(19) United States
(12) Patent Application Publication
(10) Pub. No.: US 2019/0093378 A1
(43) Pub. Date: Mar. 28, 2019

(54) Water/Swimming Pool Pump Using Solar Thermal Technology Enhancing the Overall Efficiency

(71) Applicants: Edward Earl Sweat, Maitland, FL (US); Mark Crabtree, Cape Coral, FL (US); Chris Micallef, Uttoxeter (GB)

(72) Inventors: Edward Earl Sweat, Maitland, FL (US); Mark Crabtree, Cape Coral, FL (US); Chris Micallef, Uttoxeter (GB)

(21) Appl. No.: 16/204,360

(22) Filed: Nov. 29, 2018

Related U.S. Application Data
(63) Continuation of application No. 14/936,999, filed on Nov. 10, 2015, now abandoned.

(51) Int. Cl. E04H 4/12; F24S 20/00; F24S 20/40

(52) U.S. Cl. CPC E04H 4/129; F24S 20/40; F24S 20/02

(57) ABSTRACT

A heating system is described that uses solar thermal technology in the heating cycle using the compression principle to reduce the electrical consumption of the compressors, thereby increasing the efficiency of systems being used for heating with an increased refrigerant flow. Thermal energy provided from solar thermal energy collectors may be used. The rate of efficiency of the total heating system depends heavily on the size and construction of the heat exchanger array and the pipework to and from these heat exchangers. The system uses proper dimensioning, components in the pipework, and logic groups with sensors and actuators attached in that pipework to increase energy efficiency.

### CROSS REFERENCE TO RELATED APPLICATIONS

This application is a continuation application of U.S. nonprovisional patent application Ser. No. 14/936,999 filed on Nov. 10, 2018. The foregoing application is incorporated in its entirety herein by reference.

### FIELD OF THE INVENTION

The invention relates to a heating system using the compression cycle process combined with a single heat-exchanger or array connected to it with a specific pipework enhancing the efficiency of the heating system by reducing the electrical consumption of the compressor. More particularly, the invention relates to a more efficient heat pump system for heating water in a water tank or swimming pool using solar energy.

### BACKGROUND

A modern day heat pump system in the main uses compression cycle principle. A refrigerant in gaseous state is compressed by a compressor and afterwards liquefied in the heat exchanger. The refrigerant is liquefied by having the heat extracted from it by the water passing through the heat exchanger or evaporator.

The compressor has two main components, a hydraulic chamber which sucks the gaseous refrigerant in, compresses it and pushes it out and drives the moving parts in the hydraulic chamber to make the compression and circulation in the heating cycle possible. The drive may be indirect through an attached gear box, belt or direct with an attached motor, for example electrically driven.

Special developed control mechanisms control the complete heating cycle and its components according to the user's requirement and constantly measured parameters of temperature, pressure and flow in the cycle.

The compression of the refrigerant requires a high amount of work. Typically 80% of the total energy used by the heat pump system is consumed by the compressor, independently if the drive is direct or indirectly flanged to the hydraulic part of the compressor.

The heat exchanger or condenser is situated directly after compressor, and the other important part of the cycle contains at least 2 parts. WO2015041216 describes some means and methods for enhancing the efficiencies of the heat exchangers on their own.

U.S. Patent Application Publication No. 2012/0117986 (“the '986 application”) describes the placement of a solar thermal panel with vacuum glass tubes after the compressor and ahead of the condenser. This heats up the refrigerant and compresses the refrigerant further. By applying the ideal gas law it reduces the energy consumption of the compressor. The '986 application describes a solar panel with vacuum tube glass, not other types of panels like for example flat glass panels or CPD systems.

Newer improvements in the development of flat gas panels make also these types of solar panels suitable to heat up the refrigerant gas. Also other types of heat sources, heating up the refrigerant directly or indirectly as waste heat can be used to heat up the refrigerant.

### SUMMARY

To achieve the best efficiency of a heat pump type system, heating the gas as high as possible is very important without creating detrimental effects in the cycle or its components. Matching the size of the heat source applied to the refrigerant with the overall capacity of the heating system is also important. A solar thermal collector that is too small will have no visible effect on the thermodynamics and therefore the efficiency. The size of the heat source is very important for the larger systems and compressor systems with more than one compressor involved.

The refrigerant contains oil and other liquids ensuring safe, secure and efficient working of its components and flow. These add-ons are dispersed into the refrigerant and flow with them. To ensure proper working of the heating system, it must be ensured that the add-ons are also flowing through the whole cycle and are not trapped and caught in one place and cause a starvation in the components to which they are dedicated. Thus, the pipework and heat exchangers must be constructed and installed in a way so that the oil dispensed in the refrigerant may be caught prior to entering the heat exchanger, therefore ensuring a safe flow back to the compressor.

The heat sources must be able to be bypassed or controlled variably to follow the actual ambient situation. For example, when the system is heating and there is no available sun, the heat exchanger may cool down the refrigerant after the compressor before the refrigerant reaches the heat exchanger or evaporator. Running the refrigerant through the heat exchanger would be detrimental from an energy consumption perspective in this case, and therefore, the heat exchanger must be bypassed.

Most of today's heat pumps use electrically driven compressors and consume a great deal of electrical energy. More than 80% of the total consumption system is caused by the compressor. The more energy may be saved, the less carbon dioxide is produced. This heating system strives for the lowest electrical consumption from the compressor while maintaining the desired system capacity.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 shows one embodiment of a system for heating water using solar energy.

FIG. 2 shows another embodiment of the system of FIG. 1 with the addition of a bypass system for the compressor.

FIG. 3 shows another embodiment of the system of FIG. 1 with the addition of a bypass system for the solar thermal collection system.

FIG. 4 shows another embodiment of the system of FIG. 1 with the addition of a logic controller for measuring and controlling the systems new parameters.

### DETAILED DESCRIPTION

The invention provides a heating system that reduces the electrical consumption of a compressor by heating up the refrigerant further after the compressor in the cycle, which is sized ideally to the system's capacity and the actual conditions and which follows them for always providing the most ideal working point and removing potential harm to the system, while at the same time increasing the capacity of the system. The heating system is useful for heating water for a hot water tank, a swimming pool, or similar containers of water.

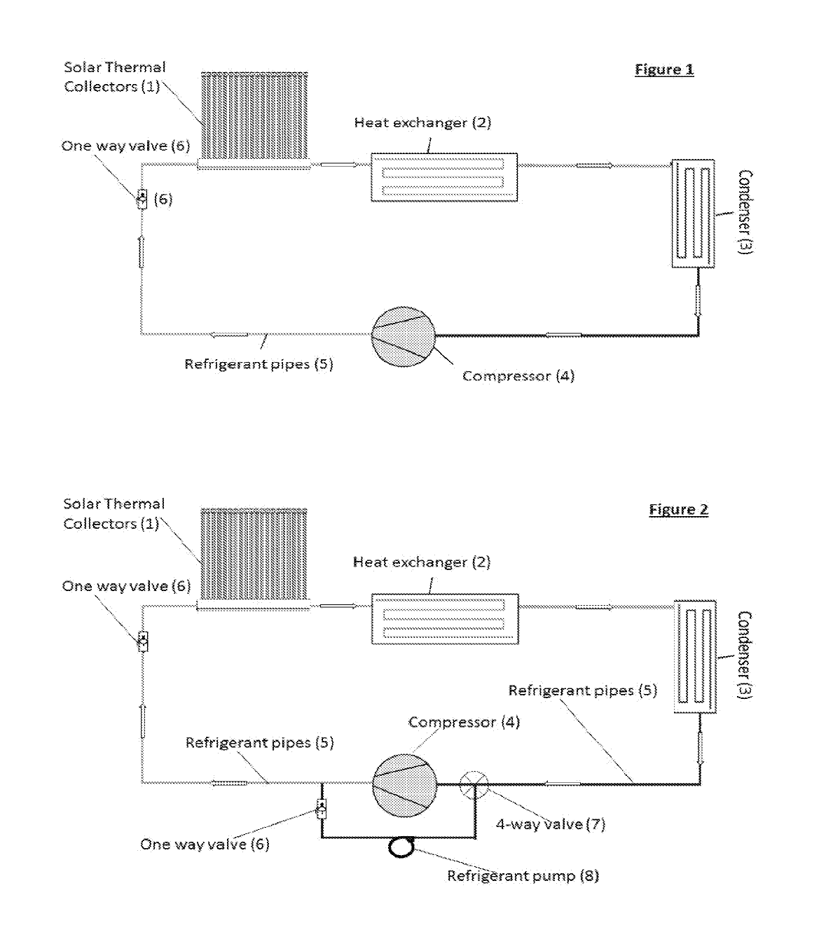

As shown in FIGS. 1 and 2, the heating system uses a compression cycle process, and contains at least the following components: a single solar thermal energy collector or an array of solar thermal energy collectors 1 to heat a refrigerant, a heat exchanger (or evaporator) 2, a condenser 3, a compressor 4, refrigerant pipes and transmission lines 5, and a control unit (also referred to herein as a central control unit or a logic controller) 9. These components are connected to each other in a cycle as shown in the drawings. The heating system may include other components in addition to those identified above such as, for example, one or more one-way valves 6, one or more 4-way valves 7, and/or a refrigerant pump 8. The compressor and the valves in the heating cycle can vary their performance depending on the results received by the sensors and processed in the control unit.

The solar thermal energy collector or collectors can be at least refrigerant-grade units. The one or more solar thermal energy collectors can include coaxial heat exchangers, tube and shell heat exchangers, plate heat exchangers, or a combination of all of them, transferring the heat from the sun's radiation to heat the refrigerant in the heating system.

In one embodiment, the heat exchanger can include a flat metal plate capable of absorbing the sun's heat, one or inner pipes, or a combination of both to heat the refrigerant in the heating system.

In another embodiment, the heat exchanger can include solar thermal panels with vacuum glass tubes or flat panel glass with layers absorbing sun light and converting the light into heat, one or more inner pipes, or a combination of both to heat the refrigerant in the heating system.

The basic principle of a heating cycle system using the compression cycle process is to evaporate a liquid in a heat exchanger, commonly called the evaporator. Evaporating the liquid requires heat to be removed from the medium around the evaporator, typically water for pool heat pumps. The amount of heat required for evaporation is determined by the amount of liquid which evaporates, or considered per time \dot{Q}=L*\dot{m}, where \dot{Q} is the heat per second which is required to be put into the liquid so it may evaporate, L is the specific enthalpy of the liquid which evaporates, being a constant, and m is the amount of liquid which evaporates per second. The more liquid per second that evaporates, the more heat is required for evaporation, and therefore, more heat is removed by the passing water.

Conventional compressors had a fixed speed drive meaning that the mass flow being produced by the compressor was always constant. Newer compressors have varying speeds, as for example the commonly known “DC inverter units.” They offer a variable mass flow of the refrigerant. The slower the compressors work, the less mass flow they have. This may be also achieved through multi-staged compressors, wherein several compressors with fixed speed are installed parallel (or a mixture of fixed and variable speed). They feed their output into a common refrigerant line. Depending on the required output one or more or all are switched in to supply enough mass flow of the refrigerant.

This heating system reduces the electrical consumption of the compressor by increasing the mass flow and/or heat caused by the refrigerant being further heated after the compressor. The heat exchanger, being placed after the compressor and ahead of the heat exchanger transfers heat into the gaseous refrigerant. Since the refrigerant is fully gaseous, the ideal gas law therefore applies:

p*V=n*R*T

The pressure of the gas in its contained volume is equal to the number of molecules and its temperature. R is the general gas constant, being constant. The volume of the refrigerant gas where it is contained does not change, but remains constant. When the gas is heated, as for example by 40° C., either the pressure rises or the number of gas molecules must decrease.

The heat exchangers and the pipework for connecting them to the cycle must not harm the heating system and its components. Oil and other components added to the refrigerant must be able to flow around the full cycle and not collect in the solar collectors or its pipework.

The compressor of the heating system can be a variable drive, fixed speed or multi-staged compression compressor and is connected to a central control unit. The central control unit of the heating system measures the parameters of the cycle at various points considering the user's requirements and controlling the components and therefore mass flow. The more the heat exchanger increases the mass flow in the cycle, the more it takes over this task from the compressor and the less the compressor needs to provide the mass flow. The less the compressor needs to work, the less energy it consumes.

The task is solved by the heating system, wherein the heat for the solar collectors to heat up the refrigerant derives from the sun's free thermal energy. The solar collectors can be made as one or more solar thermal vacuum tubes combined in an array and pipework connected to the heating cycle system. The solar thermal panels use the radiation of the sun to heat the refrigerant flowing through them.

The one or more heat exchangers of the heating system can be connected in an array allowing an increase in the heat exchanged with an increased capacity of the total heating system.

The heating system can also include a dedicated pipework that connects the solar collectors to the heating cycle in the way that least pressure is incurred by them and also specific solar collectors may be added or removed temporarily form the heating system to vary the amount of heat being transferred to the refrigerant. The amount of pressure being incurred depends on the pipe diameter, the length of the various branches and components being inserted into the pipework.

The heating system can also use a specific calculation method to consider the various parameters of the refrigerant flowing through the heating cycle, the user's requirements, and the heat being transferred to calculate the ideal pipe diameters, pipe lengths, shape of components to be added, required inner surface of the pipes, and components for the various parts of the parts of the pipework and solar collectors.

The solar collectors are constructed and built in the system in a way to allow oil and other additives to flow smooth through them and not to trap in the pipework or heat exchangers thereby causing harm to the parts requiring their abilities.

The heating system can also include an oil separator and/or oil trap in the heat exchanger directly at the entrance for the refrigerant into the manifold and prior to separating from the manifold pipe into the numerous individual pipes.

The heating system can further include an additional control system with sensors for measuring temperature and/or pressure in the cycle to override the signal given from the central control unit of the system to the compressor, to consider changed parameters in the cycle caused by rapid changes the heating of the refrigerant, and to stabilize the operation of the heating system.

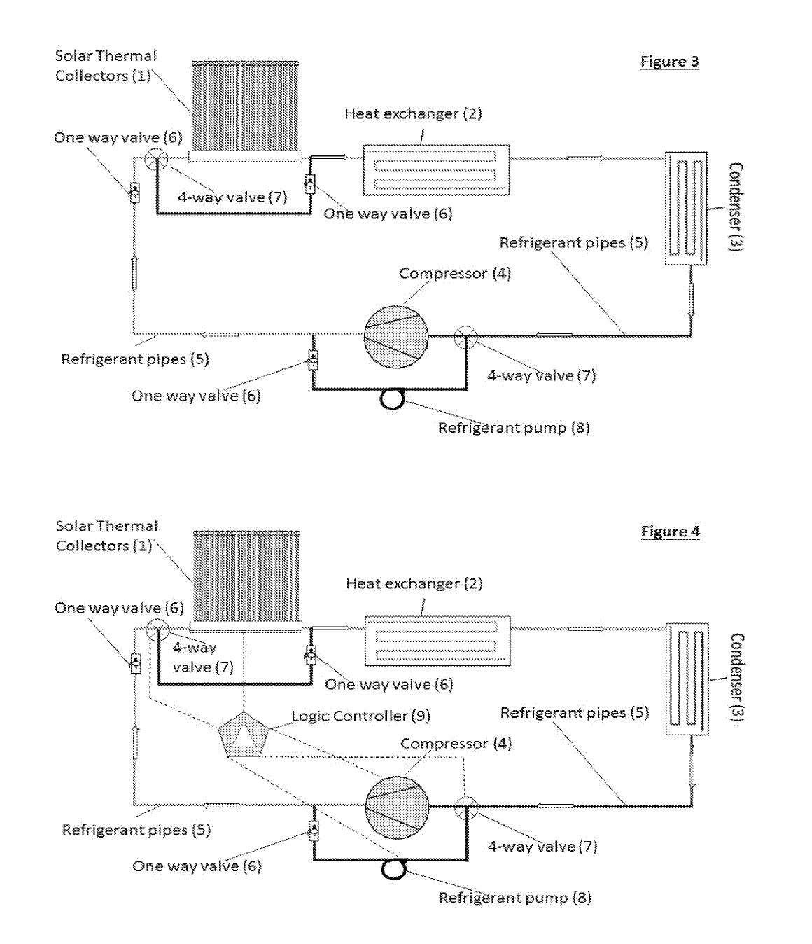

The heating system can also include an additional 4-way valve as shown in FIGS. 3 and 4. The heating system can include an additional 4-way valve connected to the central control unit, wherein the refrigerant lines connect the 4-way valve with the solar collectors and other components in the system. The 4-way valve identifies the temperature in the solar thermal collectors and determines the difference between the temperature of the refrigerant leaving the compressor versus the temperature in the solar collectors. When the solar collector's temperature is lower than that of the refrigerant leaving the compressor, the 4-way valve will allow the system to bypass the solar collectors.

In another embodiment, the heating system can include an additional 4-way valve connected to the central control unit, wherein the refrigerant lines connect the 4-way valve with the refrigerant pipes before and after the compressor. This embodiment allows the control system of the central control unit to shut down the compressor and allows the refrigerant pump to pass the refrigerant directly to the solar collectors and other components in the system. The 4-way valve identifies the temperature in the solar thermal collectors and distinguishes between the temperature of the refrigerant leaving the compressor versus the temperature in the solar collectors. When the solar collector's temperature is high enough, the central control unit of the heating system will shut down the compressors and the 4-way valve will allow the system to bypass the compressors, significantly reducing the energy consumed by the system.

The heating system operates to heat water with lower energy consumption with the same or likely improved heating capacity, and optimizes the heat being applied to the refrigerant in an ideal and variable manner without harming the components of the system.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. Water/pool heating system following the compression cycle process, which contains the components compressor (4), solar thermal collectors (1), heat exchanger (2), condenser (3), logic controller (9), refrigerant pipes (5), which are connected to each other in the heating cycle, where the refrigerant pipes (5) connect the compressor (4) with the solar thermal collectors (1), with the heat exchanger (2) with the condenser (3).

2. Water/pool heating system characterized by claim 1, where the heat exchanger (2), boosted by the temperature from the solar collectors (1) may heat the surrounding liquid coming into touch with the heat exchanger (2).

3. Water/pool heating system characterized by claim 1, where the compressor (4) may be a compressor with variable or fixed speed.

4. Water/pool heating system characterized by claim 1, where the heating system may consist of more than one heat exchanger (2),

5. Water/pool heating system characterized by claim 1, which contains additionally a 4 way valve (7) being connected to the logic controller (9), where the refrigerant lines (5) connect the 4-way valve (7) with the solar collector/s (1), the heat exchanger/s (2) and the condenser (3) and the compressor (4). Allowing the system to bypass the solar collectors as described in Description [0032].

6. Method for a water/pool heating system, which contains in its heating cycle at least refrigerant grade solar thermal collector/s and a heat exchanger.

7. Method for a Water/pool heating system as characterized by claim 6, creating energy consumption reduction either from the compressor (4) or by bypassing the compressor (4), by taking advantage of the increased mass flow of the refrigerant gas created by the further heat generated in the solar thermal collector/s (1).

8. Method for a heating system as characterized by claim 6, creating energy consumption reduction in the compressor (4) or by bypassing the compressor (4) by using the increased temperature difference of the refrigerant gas created by the further heat generated in the solar thermal collector/s (1).

9. Method for a heating system as characterized by claim 6, creating energy consumption reduction in the compressor (4) or by bypassing the compressor (4) by taking advantage of a combination of both, increased mass flow and increased temperature difference of the refrigerant gas created by the further heat generated in the solar thermal collector/s (1).

10. The solar collectors (1) being coaxial heat exchangers or tube and shell heat exchangers or plate heat exchangers or a combination of all of them, transferring the heat from the suns radiation to heat up the refrigerant in the water/pool heating system as characterized in claim 1.

11. The heat exchangers as characterized in claim 10 being solar thermal panels with vacuum glass tubes or flat panel glass with layers absorbing sun light and converting the light into heat, with inner pipes or combination of both to heat up the refrigerant in the water/pool heating system as characterized in claim 1.

12. The heat exchangers as characterized in claim 10 being a flat metal plate absorbing the suns heat, with inner pipes or combination of both to heat up the refrigerant in the water/pool heating system as characterized in claim.
